(19) United States
(12) Patent Application Publication
(10) Pub. No.: US 2009/0174327 A1
(43) Pub. Date: Jul. 9, 2009

(54) RAPID RE-STRIKE CERAMIC DISCHARGE METAL HALIDE LAMP

(75) Inventors: Ray G. Gibson, Bath, NY (US); Jay Joseph Palmer, Hammondsport, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,685

(22) PCT Filed: Nov. 18, 2005
(86) PCT No.: PCT/IB05/53817

§ 371 Date: May 18, 2007

Related U.S. Application Data
(60) Provisional application No. 60/629,797, filed on Nov. 19, 2004.

(51) Int. Cl. H01J 61/26; H01J 61/12; H01J 61/16

(52) U.S. Cl. 313/562; 313/637; 313/573; 313/643

(57) ABSTRACT

The hot re-strike time of a high wattage (150 W or greater) ceramic discharge metal halide (CDM) lamp is reduced by: (a) increasing the ratio A of the diameter (D2) of the outer bulb (1) to the inner diameter (ID) of the discharge vessel (3); or (b) filling the outer bulb with an inactive gas such as nitrogen, helium, neon, argon, krypton or xenon; or by implementing both (a) and (b). The hot re-strike time can be further reduced by combining (a) and/or (b) with (c), the addition of a getter metal for iodine, such as Sc, Ce or Na, to the discharge vessel (3).

This invention relates to ceramic discharge metal halide (CDM) lamps, and more particularly relates to CDM lamps with a significantly reduced hot re-strike time.

CDM lamps typically require ten to fifteen minutes after a momentary power outage to cool sufficiently to reach a breakdown voltage allowing re-strike to occur. By comparison, quartz metal halide lamps typically exhibit re-strike times in the range of from about six to ten minutes, and high pressure sodium (HPS) lamps typically exhibit re-strike times in the range of from about one to two minutes. In addition, HPS lamps can exhibit essentially instant re-strike times when employing a second, inactive discharge tube in parallel with the first, which strikes as soon as power is restored. This approach has proven unworkable in CDM lamps, particularly the high wattage versions, because the much higher vapor pressures in the CDM lamps.

In accordance with the present invention, it has been discovered that by increasing the size of the outer bulb relative to the ceramic discharge vessel of a high wattage (150 W or greater) CDM lamp, the hot re-strike time is reduced. This size difference is represented herein by the ratio A, which is the ratio of the diameter D of the outer bulb to the inside diameter ID of the ceramic discharge vessel. This ratio must be greater than about 5.8, and is preferably at least about 8.7.

It has been further discovered that by filling the outer bulb of such a lamp with an inactive gas such as one or more of nitrogen, helium, neon, argon, krypton or xenon, the hot re-strike time is also reduced.

It has been further discovered that in such a lamp in which the hot re-strike time has been reduced by one or both of the above means, the hot re-strike time is further reduced by the addition to the discharge tube a metal having a gettering capacity for iodine, such as Sc, Ce or Na.

In summary, the hot re-strike time of a high wattage (150 W or greater) ceramic discharge metal halide (CDM) lamp is reduced by: (a) increasing the ratio A of the diameter D of the outer bulb to the inner diameter ID of the discharge vessel; or (b) filling the outer bulb with an inactive gas such as one or more of nitrogen, helium, neon, argon, krypton or xenon; or by implementing both (a) and (b). The hot re-strike time can be further reduced by combining (a) and/or (b) with (c), the addition of a getter metal for iodine, such as Sc, Ce or Na, to the discharge vessel.

In accordance with a preferred embodiment of the invention, (a), (b) and (c) are combined to result in a high wattage (150 W or more) CDM lamp wherein the ratio A is chosen to be at least 12; nitrogen gas is chosen to be present in the outer bulb in an amount to result in a pressure of from about 100 to 500 Torr; and Sc metal is added to the salts of the discharge tube in the amount of from about 3.75 to 6.25 wt. %.

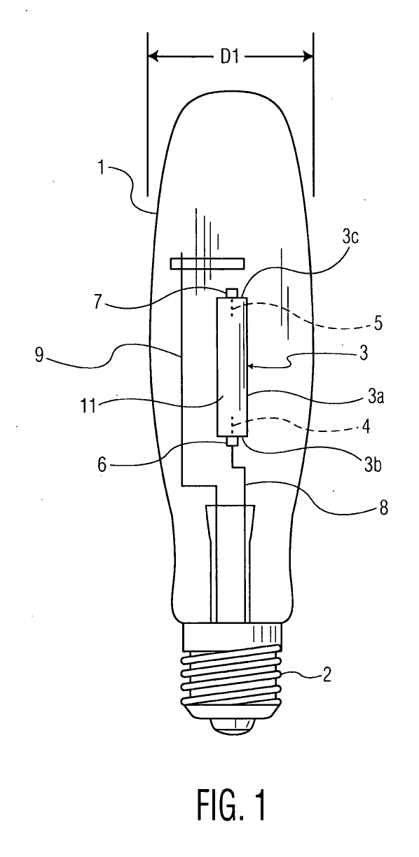

FIG. 1 is a schematic representation of one embodiment of a high wattage CDM lamp of the prior art;

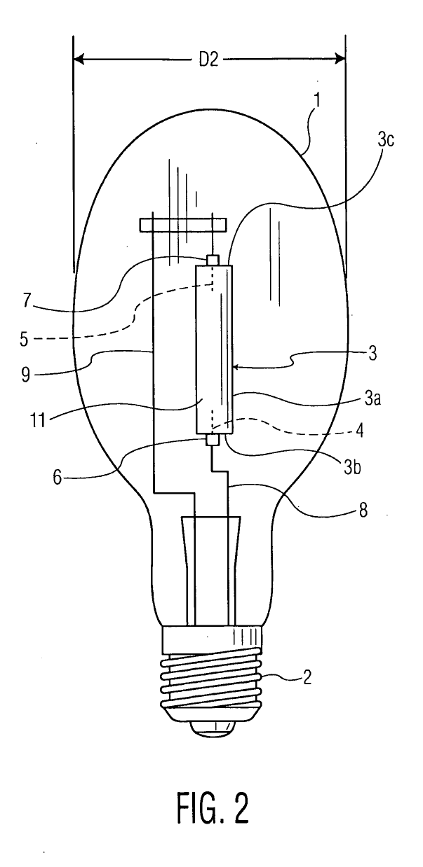

FIG. 2 is a schematic representation of one embodiment of a high wattage CDM lamp of the invention;

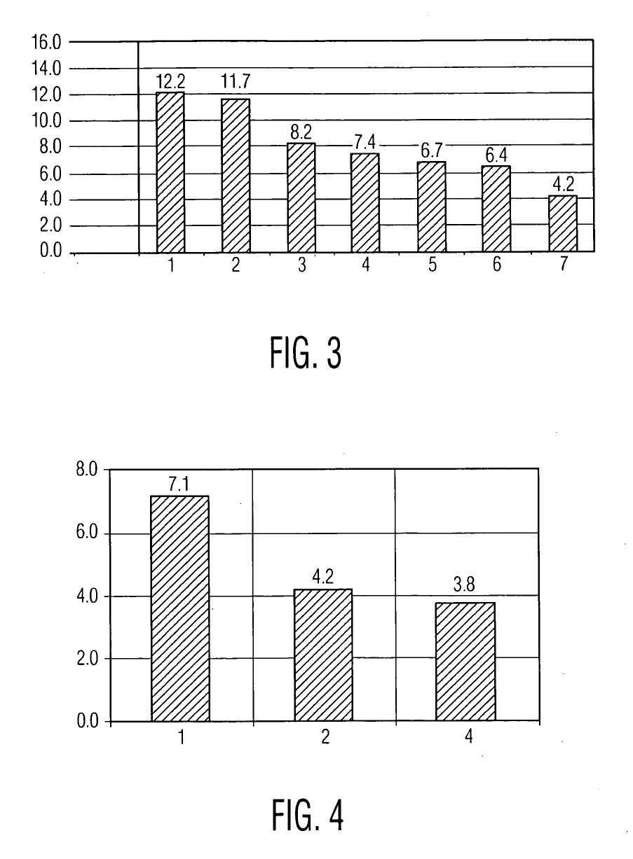

FIG. 3 is a bar chart of hot re-strike time, in minutes, versus design features of a high wattage CDM lamp of the prior art and various embodiments of high wattage CDM lamps of the invention; and

FIG. 4 is a bar chart of hot re-strike time, in minutes, versus Sc dose, in mg, of one embodiment of a high wattage CDM lamp of the invention.

FIG. 1 is a schematic diagram of a high wattage (150 W or higher) CDM lamp of the prior art. The lamp is provided with a ceramic discharge vessel 3, typically of polycrystalline alumina (PCA), having a ceramic sidewall 3a, and ceramic end walls 3b and 3c, which vessel 3 has in inner diameter ID and encloses a discharge space 11 containing an ionizable filling. Electrodes 4, 5 extend through plugs 6 and 7, and receive current from conductors 8, 9 which also support the discharge vessel 3. The vessel 3 is surrounded by an evacuated outer bulb 1 which has a diameter D1 and is sealed with a lamp cap 2 at one end.

The ionizable filling of the discharge vessel 3 typically includes an ignition gas such as Xe, Ar or Kr. The ionizable filling also includes Hg and iodides of Na, Ca, Tl and rare earths, such as Dy, Ho and Tm.

Such a prior art CDM lamp is described in more detail in U.S. Pat. Nos. 6,555,962; 6,031,332; and 5,973,453, the entire specifications of which are incorporated herein by reference. Typical hot re-strike times for these lamps are from about ten to fifteen minutes.

FIG. 2 is a schematic diagram of one embodiment of a high wattage CDM lamp of the invention. This embodiment is similar to the prior art lamp of FIG. 1, and has been given the same reference numerals for similar elements, except for the outer bulb 10, which has a larger size than outer bulb 1 of FIG. 1, as indicated by the diameter D2, which is larger than D1. Since the inner diameter ID of the discharge vessel is unchanged, the ratio A=D2/ID is larger than the ratio D1/ID.

FIG. 3 is a bar chart of hot re-strike time, in minutes, versus design features of seven different lamp designs. The lamps were all CDM400W/100V lamps operated on a commercial S51-type CWA ballast in a demountable outer bulb system connected to a vacuum pump. The lamps were switched off for five seconds before re-applying power for the re-strike test.

The discharge vessels were PCA arc tubes with standard dimensions of 9.8 mm×38 mm (ID×IL), and sealed to the PCA with a high temperature glass. The discharge vessels were charged with a salt mixture containing NaI, CaI₂, TlI and rare earth iodides. Xe with a small addition of Kr as a starting aid was used as the ignition gas. Hg was dosed at 4.6 mg, except for the lamps whose outer bulbs were gas-filled. These lamps were dosed with from 5 to 13 mg of Hg in order to obtain operation to within 10% of 400 W. The discharge vessels were seasoned for fifteen minutes before testing.

Variables in the series of seven lamp designs (designated 1-7) include two different outer bulb sizes, the first representing the prior art lamp and designated ED18, having a diameter of about 2¼ inch, and the second, designated ED37, having a diameter of about 4 ⅝ inch, approximately 105% of the diameter of the ED18 bulb. Some outer bulbs were maintained in vacuum, while others were filled with nitrogen to a pressure of 300 Torr. Vacuum-containing lamps had barium ring getters, while gas filled lamps had solid state getters. Some discharge vessels were given a dose of 2 mg of scandium metal, which corresponded to 5 wt. % of the salts.

FIG. 3 shows a progressive reduction in the hot re-strike time as different variables were introduced, either alone or in different combinations. Bar 1 represents the hot re-strike time of lamp 1, a lamp of the prior art having an ED18 outer bulb maintained in vacuum, and having a hot re-strike time of 12.2 minutes. Bar 2 represents the hot re-strike time of lamp 2, which is lamp 1 modified by replacing the ED18 outer bulb with a larger ED37 outer bulb, resulting in a reduction of the hot re-strike time to 11.7 minutes. Bar 3 represents the hot re-strike time of lamp 3, which is lamp 1 modified by filling the outer bulb with nitrogen, resulting in a reduction of the hot re-strike time to 8.2 minutes. Bar 4 represents the hot re-strike time of lamp 4, which is lamp 1 modified by combining the larger ED37 outer bulb with a nitrogen fill, resulting in a reduction of the hot re-strike time to 7.4 minutes. Bar 5 represents the hot re-strike time of lamp 5, which is lamp 1 modified by combining the larger ED37 outer bulb with the addition of Sc to the discharge tube, resulting in a reduction of the hot re-strike time to 6.7 minutes. Bar 6 represents the hot re-strike time of lamp 6, which is lamp 1 modified by combining the nitrogen fill with the addition of Sc, resulting in a reduction of the hot re-strike time to 6.4 minutes. Bar 7 represents the hot re-strike time of lamp 7, which is lamp 1 modified by combining the larger ED37 outer bulb, the nitrogen fill and the addition of Sc, resulting in a reduction of the hot re-strike time to 4.2 minutes.

These results demonstrate that the two design features of larger size of the outer envelope, and gas fill of the outer envelope each results in a decrease of the hot re-strike time (to 11.7 and 8.2 minutes, respectively), while the combination of these two features results in a further decrease (to 7.4 minutes), and the combination of either of these features with the addition of Sc to the discharge tube results in further decreases (to 6.7 and 6.4 minutes, respectively), and the combination of all three features results in the greatest decrease (to 4.2 minutes).

It can also be seen that the gas fill alone has a somewhat larger effect than an increase in the bulb size alone, resulting in a decrease in the hot re-strike time from 12.2 to 8.2 minutes, or 32%, for lamp 3, versus a decrease from 12.2 to 11.7 minutes, or 4% for lamp 2. This effect can also be seen by comparing the hot re-strike times for lamps 5 and 7, having both a larger outer bulb and Sc. The addition of the gas fill results in a decrease of the hot re-strike time from 6.7 minutes for lamp 5 to 4.2 minutes for lamp 7, a decrease of approximately 37%.

FIG. 4 is a bar chart of hot re-strike time, in minutes, versus Sc dose, in mg, for CDM400 W lamps of the invention having a gas filled ED37 outer bulb and discharge vessels containing 1 mg, 2 mg and 4 mg of scandium metal, respectively. The lamps, designated 8-10, were constructed and tested for hot re-strike times in the same manner as the lamps 1-7 described above. FIG. 4 shows that hot re-strike times vary from 7.1 minutes for lamp 8 with 1 mg of Sc, to 3.8 minutes for lamp 10 with 4 mg of Sc.

These results can be compared with the hot re-strike time of 7.4 minutes for lamp 4, having a gas filled ED37 envelope, but no Sc. While lamp 8 showed about 4% improvement over lamp 4, further tests showed inconsistent results. Lamp 9 showed a much larger improvement of about 43% over lamp 4, and lamp 10 showed a further improvement over lamp 9 of about 10%. However, the larger amount of Sc in lamp 10 reduced the lamp voltage by a factor of 2 thus requiring more than 10 mg of Hg to be added.

Based on these and other considerations, it is preferred to add the Sc in an amount of at least about 1.5 mg., below which improvements in hot re-strike time tend to be slight or inconsistent, and no more than about 2.5 mg., above which further improvements are obtainable, but may be accompanied by significant drops in lamp voltage.

It is important that the iodine getter be added as the metal in order to take up the excess iodine while the lamp is cooling, thus reducing the time to reach a low enough breakdown voltage for re-strike to occur.

Although not relied upon to define the invention, theory suggests that during lamp cooling, the highly electronegative I⁻ ion forms, depleting the discharge space of the free electrons needed for the lamp to re-strike. If excess Hg is present, it can getter the excess iodide by forming HgI₂. However, HgI₂ forms and condenses out of the hot discharge gas at a relatively low temperature. The addition of a getter metal such as Sc results in the preferential formation of ScI₃, which removes excess iodide ions more quickly because it forms and condenses out of the hot discharge gas at a higher temperature than HgI₂. The embodiments and examples set forth herein are presented to explain the present invention and its practical application and to thereby enable those skilled in the art to make and utilize the invention. Those skilled in the art, however, will recognize that the foregoing description and examples have been presented for the purpose of illustration and example only. Other embodiments, variations of embodiments, and equivalents, as well as other aspect, objects, and advantages of the invention, will be apparent to those skilled in the art. Thus, the principles of the present invention can be obtained from a study of the drawings, the disclosure, and the appended claims.

1. A high wattage ceramic discharge metal halide lamp comprising;
a ceramic discharge vessel (3) having a side wall (3a) and end walls (3b, 3c), the ceramic discharge vessel (3) enclosing a discharge space (11) containing a fill including salts, the fill capable of maintaining a gas discharge under the influence of an applied voltage;
a pair of electrodes (4, 5) extending through the end walls (3b, 3c) into the discharge space (11);
a pair of conductors (8, 9) for supplying current to the electrodes (4, 5) and for supporting the ceramic discharge vessel;
an outer bulb (1) surrounding the ceramic discharge vessel (3), the electrodes (4, 5) and the conductors (8, 9); and
an end cap (2) for sealing the outer bulb and for providing through-connections from an external current source to the conductors (8, 9);
characterized in that the ratio of the diameter D2 of the outer bulb (1) to the inside diameter ID of the ceramic discharge vessel (3) is greater than 5.8.

2. The high wattage ceramic discharge metal halide lamp of claim 1 in which the ratio of the diameter D2 of the outer bulb (1) to the inside diameter ID of the ceramic discharge vessel (3) to is at least 8.7.

3. The high wattage ceramic discharge metal halide lamp of claim 2 in which the ratio of the diameter D2 of the outer bulb (1) to the inside diameter ID of the ceramic discharge vessel (3) to is at least 12.

4. The high wattage ceramic discharge metal halide lamp of claim 1 in which an inactive gas is present in the outer bulb (1).

5. The high wattage ceramic discharge metal halide lamp of claim 4 in which the inactive gas is one or more of the gases selected from the group consisting of nitrogen, helium, neon, argon, krypton and xenon.

6. The high wattage ceramic discharge metal halide lamp of claim 5 in which the inactive gas is nitrogen.

7. The high wattage ceramic discharge metal halide lamp of claim 6 in which the nitrogen is present in the outer bulb (1) at a pressure within the range of about 100 to 500 Torr.

8. The high wattage ceramic discharge metal halide lamp of claim 1 in which a getter metal for iodine is present in the discharge vessel (3).

9. The high wattage ceramic discharge metal halide lamp of claim 8 in which the getter metal is selected from the group consisting of Sc, Ce and Na.

10. The high wattage ceramic discharge metal halide lamp of claim 9 in which the getter metal is Sc.

11. The high wattage ceramic discharge metal halide lamp of claim 10 in which the scandium is present in the discharge vessel (3) in the amount of from about 3.75 to 6.25 wt. % of the salts.

12. The high wattage ceramic discharge metal halide lamp of claim 11 in which the scandium is present in the discharge vessel (3) in the amount of about 5 wt. % of the salts.

13. The high wattage ceramic discharge metal halide lamp of claim 7 in which scandium is present in the discharge vessel (3).

14. The high wattage ceramic discharge metal halide lamp of claim 13 in which the scandium is present in the discharge vessel (3) in the amount of from about 3.75 to 6.25 wt. % of the salts.

15. The high wattage ceramic discharge metal halide lamp of claim 14 in which the scandium is present in the discharge vessel (3) in the amount of about 5 wt. % of the salts.

16. A high wattage ceramic discharge metal halide lamp comprising;
a ceramic discharge vessel (3) having a side wall (3a) and end walls (3b, 3c), the ceramic discharge vessel (3) enclosing a discharge space (11) containing a fill including salts, the fill capable of maintaining a gas discharge under the influence of an applied voltage;
a pair of electrodes (4, 5) extending through the end walls (3b, 3c) into the discharge space (11);
a pair of conductors (8, 9) for supplying current to the electrodes (4, 5) and for supporting the ceramic discharge vessel;
an outer bulb (1) surrounding the ceramic discharge vessel (3), the electrodes (4, 5) and the conductors (8, 9); and
an end cap (2) for sealing the outer bulb and for providing through-connections from an external current source to the conductors (8, 9);
characterized in that an inactive gas is present in the outer bulb.

17. The high wattage ceramic discharge metal halide lamp of claim 16 in which the inactive gas is one or more of the gases selected from the group consisting of nitrogen, helium, neon, argon, krypton and xenon.

18. The high wattage ceramic discharge metal halide lamp of claim 17 in which the inactive gas is nitrogen.

19. The high wattage ceramic discharge metal halide lamp of claim 18 in which the nitrogen is present in the outer bulb (1) at a pressure within the range of about 100 to 500 Torr.

20. The high wattage ceramic discharge metal halide lamp of claim 16 in which the ratio A of the diameter D2 of the outer bulb (1) to the inside diameter ID of the ceramic discharge vessel (3) is greater than 5.8.

21. The high wattage ceramic discharge metal halide lamp of claim 20 in which the ratio of the diameter D2 of the outer bulb (1) to the inside diameter ID of the ceramic discharge vessel (3) to is at least 8.7.

22. The high wattage ceramic discharge metal halide lamp of claim 21 in which the ratio of the diameter D2 of the outer bulb (1) to the inside diameter ID of the ceramic discharge vessel (3) to is at least 12.

23. The high wattage ceramic discharge metal halide lamp of claim 16 in which a getter metal for iodine is present in the discharge vessel (3).

24. The high wattage ceramic discharge metal halide lamp of claim 23 in which the getter metal is selected from the group consisting of Sc, Ce and Na.

25. The high wattage ceramic discharge metal halide lamp of claim 24 in which the getter metal is scandium.

26. The high wattage ceramic discharge metal halide lamp of claim 25 in which the scandium is present in the discharge vessel (3) in the amount of from about 3.75 to 6.25 wt. % of the salts.

27. The high wattage ceramic discharge metal halide lamp of claim 26 in which the scandium is present in the discharge vessel (3) in the amount of about 5 wt. % of the salts.

28. The high wattage ceramic discharge metal halide lamp of claim 20 in which scandium is present in the discharge vessel (3).

29. The high wattage ceramic discharge metal halide lamp of claim 28 in which the scandium is present in the discharge vessel (3) in the amount of from about 3.75 to 6.25 wt. % of the salts.

30. The high wattage ceramic discharge metal halide lamp of claim 29 in which the scandium is present in the discharge vessel (3) in the amount of about 5 wt. % of the salts.
